(19) United States
(12) Patent Application Publication
(10) Pub. No.: US 2007/0287463 A1
(43) Pub. Date: Dec. 13, 2007

(54) Telecommunications Services Apparatus And Method For Modifying The Routing Of Mobile Terminated Short Messages (Sms)

(75) Inventor: Jeffrey Wilson, Hampshire (GB)

Correspondence Address: RENNER OTTO BOISSELLE & SKLAR, LLP, 1621 EUCLID AVENUE, NINETEENTH FLOOR, CLEVELAND, OH, 44115, US

(73) Assignee: INTELLPROP LIMITED, Le Truchot St Peter Port, Guernsey (GB)

(21) Appl. No.: 10/599,496

(22) PCT Filed: Mar. 29, 2005
(86) PCT No.: PCT/GB05/01227

§ 371 Date: Jul. 12, 2007

(30) Foreign Application Priority Data
Aug. 11, 2004 (GB) 0417875.2
Mar. 29, 2004 (GB) 0407009.0

(51) Int. Cl. H04Q 7/20

(52) U.S. Cl. 455/445; 455/466

(57) ABSTRACT

A flag in a home location register of a telephone network is used to control availability of processing features, such as text message SMS processing features, to the message recipient, providing functionality similar to “class of service” in a normal telephone exchange. Mobile terminated sort messages (SMS-MT) are always routed through the home PLMN of the recipient by modifying the response to the SRI-SM signal. Instead of delivering the address of the visited MSC of the recipient, the address of a SMS router in the home PLMN is sent back to the interrogating SMSC.

This invention concerns the field of mobile telecommunications and in particular the areas of voice and text communication. More specifically the invention relates to telecommunications services apparatus and methods for use with a mobile telephone system, whereby mobile terminated text services may be selectively offered on existing mobile telephone networks. The invention is applicable in particular to the GSM mobile telephony system, although in principle the technique could be applied to other types of mobile network.

GSM is well defined and specified by international standards, which define the functional blocks and the signalling messages that pass between them. GSM provides the Short Message Service (SMS) facility which allows short text messages to be sent between mobile stations. Message transmission occurs in two stages, the first being transmission of the message from the originating handset to a short message service centre (SMSC). Secondly, the SMSC then forwards the message to the destination mobile station. If the destination mobile station is unavailable then the SMSC stores the message and retries delivery later.

One aspect of the invention provides a telecommunications services apparatus for use in a mobile telecommunications network, the apparatus comprising means for receiving text messages, means for processing the received text messages, and means for controlling the availability of the text message processing according to the recipient address of the text message.

Another aspect of the invention provides a telecommunications services apparatus for use in a mobile telecommunications network, the apparatus comprising call routing means operable:

to receive a routing information request signal indicative of a telephone communication intended for a mobile terminal; to return a routing information response signal indicative of the telecommunications services apparatus instead of being indicative of the intended mobile terminal; and to control availability of processing of the telephone communication according to the returned routing information response signal.

A further aspect of the invention provides a telecommunications services method for a mobile telecommunications network, the apparatus comprising:

receiving a routing information request signal indicative of a telephone communication intended for a mobile terminal;

returning a routing information response signal indicative of a telecommunications services apparatus instead of being indicative of the intended mobile terminal; and

controlling availability of processing of the telephone communication according to the returned routing information response signal.

The GSM short message service is extremely popular and carries ever increasing levels of traffic world-wide. A large proportion of this traffic is ephemeral. However in some cases it would be desirable to be able to keep a permanent record of short messages, either sent or received, to divert messages to an alternative destination, to copy messages to a second destination, to copy messages to email, to screen messages against Spam, etc. With the present GSM system this is not possible, because in some circumstances messages do not even pass through the home network. A preferred embodiment of the present invention facilitates all of these benefits and opens up the possibility of many new types of service with both GSM text messages and voice calls, and which can be applied selectively to certain customers, or to all customers if required. Examples of uses for this invention include:
Sending copies of Short Messages either transmitted or received by a subscriber to an email system for archiving purposes.
Diversion of SMS to an alternative handset or to an equipment, e.g. for voice read-back.
Lawful interception of SMS.
Interception of incoming or outgoing voice calls for a subscriber for the purpose of, for example, recording the call.
Providing location privacy for recipients
Anti-Spam protection
Access to diverted messages
Access to messages from other means, e.g. fixed networks or email

It is known that fixed telephone exchanges offer a class of service facility whereby the set of service features offered on a particular line is configurable.

It is known that short messages may be archived by transferring them from the handset into a computer using a data link and specialised software. However this process is slow and inconvenient.

It is known that Signalling Transfer Points (STPs) or Global Title Translators (GTTs) in the network are programmed to do address translation between global addresses and the addresses of specific equipments or groups of equipments. The STPs/GTTs provide a level of indirection in network addressing.

A preferred embodiment of the invention is based on a system as disclosed in WO 03/049461, and extends it to cover application to ‘class of service’. i.e. the provision of features selective according to configuration or provisioning, as well as location privacy and usage privacy. In particular it is envisaged that advanced services could be made available to all customers or could be selectively made available to premium customers by means of a ‘class of service’ setting in the HLR.

It is desired to obtain access to the Short Messages delivered to or transmitted by some or all subscribers of a given network, or to obtain access to the audio of all calls involving subscribers of a given network, by arranging for these communications to pass through an equipment or group of equipments. As will be described, access to mobile originated messages is straightforward using known techniques, but access to mobile terminated messages is not possible in traditional network architecture. For voice calls, diversion of outgoing calls via an equipment is currently possible by the subscriber dialling a special number or code which causes the network to route the call accordingly. However diversion of incoming calls through an equipment is not straightforward. The technique to be described allows access to mobile terminated messages, and to incoming calls, in a way that can be operated selectively per subscriber. The ability to direct all messages or voice calls through equipment in the home network is very powerful and opens the possibility of a whole range of new applications.

The invention will now be described by way of example with reference to the accompanying drawings, throughout which like parts are referred to by like references, and in which:

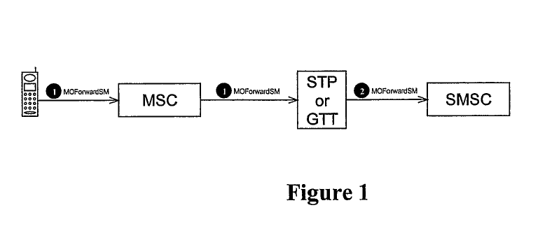

FIG. 1 is a block diagram showing normal delivery of a mobile originated message to an SMSC;

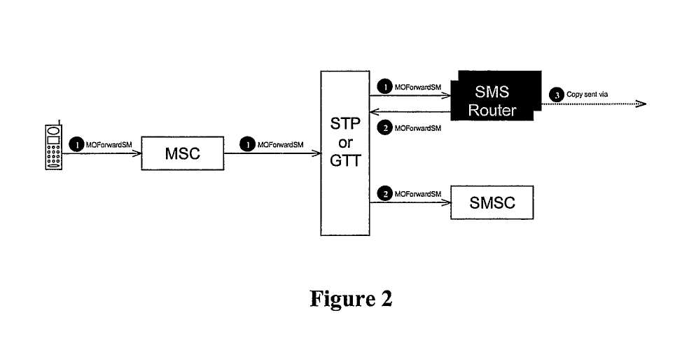

FIG. 2 shows intercepted delivery of a mobile originated message;

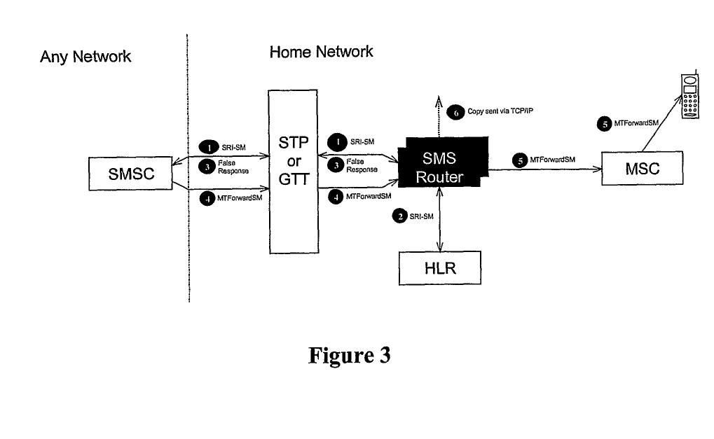

FIG. 3 shows intercepted delivery of a mobile terminated message;

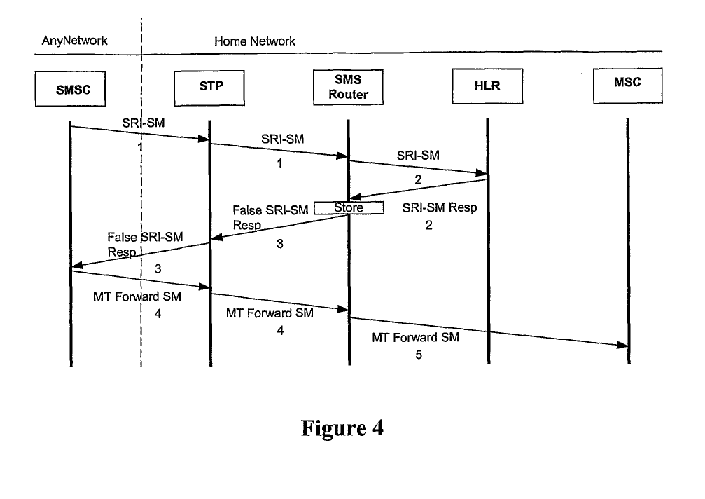

FIG. 4 is a ladder diagram of an intercepted mobile terminated message; and

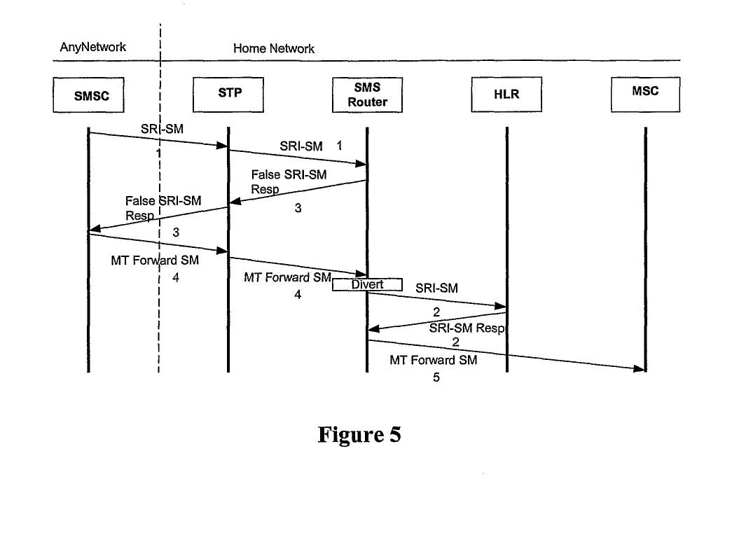

FIG. 5 is a ladder diagram of an SMS divert application.

The following description is in the context of SMS messages.

Two types of message need to be considered: those that are mobile originated (MO), i.e. sent by the subscriber and those that are mobile terminated (MT), i.e. received by the subscriber. In the mobile originated case, it is known that all messages sent by the subscriber will be delivered to the Short Message Service Centre (SMSC) address in the subscriber's home network. It is also known that Signalling Transfer Points (STPs) or Global Title Translators (GTTs) can be programmed to route all mobile originated messages sent to this address through an equipment for processing prior to being delivered, either directly to the destination or to the SMSC.

A suitable equipment for implementing the message processing is a Telsis SMS Router, manufactured by Telsis Limited, an application of which is described in WO 03/049461.

The global GSM system consists of a number of GSM networks. The network on which a subscriber is registered is known as his “home” network. When a subscriber sends a text message, the message is always delivered in the first instance to an equipment in his home network, typically an SMS Router or a Message Centre (SMSC). Delivery to an SMS Router is normally achieved by arranging for the SMS Routers in the network to take on the Global Title of the SMSCs, thereby receiving all of the MO messages addressed to an SMSC. This is the case even when the subscriber is roaming on another network. The SMS Router then queries the Home Location Register (HLR) of the destination subscriber's network and the message is then forwarded accordingly.

The global address of a Message Centre is normally programmed into the subscriber's handset. This global address is interpreted by STPs or GTTs in the GSM network in order to deliver the message to the appropriate equipment. The GSM network messaging involved in delivering a mobile originated message to an SMSC is shown in FIG. 1. The GSM network messaging involved in delivering a mobile originated message to an SMS Router is shown in FIG. 2.

The mobile terminating (MT) processing is more difficult because there is no guarantee that in normal circumstances messages delivered to a subscriber's handset will pass through the subscriber's home network at all. It is known that in order to deliver a message to a subscriber, a query must be made to the HLR of the subscriber's home network in order to determine the current location of the subscriber. In the case of short messages this query is known as “send routing information for short message” or SRI_SM. It is also known that STPs or GTTs can be programmed to route signalling messages to an alternative destination. In some cases it is possible to divert SRI_SM messages (and the SRI equivalent messages to voice calls) without diverting other types of messages. The present technique may make use of this diversion to send SRI_SM messages to the SMS Router.

Alternatively and in the preferred embodiment, the HLR can be programmed to forward some or all SRI_SMs to the SMS Router, excluding those arriving from an SMS Router. The messages so routed depend on the Class of service for the recipient, which is preferably stored as a field in the HLR. This is a key aspect of the present technique. The SMS Router is then able to reply to these queries on behalf of the HLR, while also itself querying the HLR to determine the true location of the recipient. However instead of returning the true location of the subscriber the SMS Router can return its own location in the response to the SRI_SM. The effect of this is that the short message will be delivered not to the subscriber but to the SMS Router. This is true regardless of the current locations of either the sender or the recipient. The SMS Router is then able to implement any desired processing on the text message, for example archiving to email, before finally optionally forwarding the message onto the actual location of the subscriber as indicated by the HLR. This behaviour is illustrated in FIG. 3 and the corresponding ladder diagram in FIG. 4.

In FIG. 4, the HLR query (2) is shown being made immediately the SRI_SM message arrives at the SMS Router. In practice, since the HLR response is not used until step (5), the HLR query may be delayed until after step (3), or delayed until after step (4). The reply may be sent before or after the HLR is queried, and before or after the HLR response is received. In practice, if the application being performed requires that the HLR query depend in some way on the content of the Short Message itself, such as is the case for SMS Divert, then it is preferable to delay the HLR query until after step 4. This configuration is illustrated in FIG. 5.

The combined effect of using the presently known technique for mobile originated SMS and SRI_SM response manipulation for mobile terminated SMS is that all messages to and from a subscriber may be caused to pass through an SMS Router before reaching their destination. The SMS Router is capable of acting on the contents or addresses within the message to provide additional intelligent functionality in the network such as grooming, and in conjunction with an associated processor interface and store, for providing services such as message archiving, or anti-Spam protection.

The class of service field in the HLR may be used directly to control which SRI_SMs are passed to an SMS Router for manipulated response, hence controlling which customers obtain a special class of service for their MT messages. For MO messages, the SMS Routers in the MO path may also query the HLR to determine whether a special class of service should be applied to these messages. This need not involve any additional HLR traffic, since in a direct delivery application the MO SMS Router is already querying the HLR for reasons of number portability and A-party credit check.

Very similar techniques can be used for voice calls. Instead of the SRI-SM message used for SMS, voice calls are delivered to the correct mobile station using an SRI message (Send Routing Information) directed at the HLR. If the STPs are programmed to divert SRI messages to the SMS Router, or the HLR itself is programmed to selectively route these messages on to an SMS Router, then the same principle can be used to cause incoming voice calls to be diverted via, for example, call screening equipment, a recording equipment which could make a recording in the manner described in WO 02/32092, or any other enhanced voice service. Outgoing voice calls may be diverted to the equipment by known techniques, for example the use of short dialling prefixes. For outgoing calls the equipment may query the HLR to determine the required or permitted class of service.

Text message delivery is unique in that messages are traditionally stored in Service Centres (SMSCs) in the sender's network. If the sender is a subscriber of a foreign network, then the message is stored in an SMSC outside of the recipient's network. In the normal course of message delivery, the foreign SMSC queries the recipient's HLR, and obtains the recipient's IMSI and current location, or an indication that the subscriber is absent. This information may violate the recipient's desire for privacy, especially if he is travelling. The described technique overcomes this privacy issue by always returning the address of an SMS Router as the location of the subscriber, for those recipients who have the necessary class of service set in the HLR. Redirection of a mobile terminated message to an SMS Router in the recipient's network provides privacy, because the foreign SMSC is always told that the recipient's ‘location’ is the SMS Router. No information is therefore provided to a foreign network that discloses the recipient's real location.

Routing via the home network opens the possibility of providing advanced applications and management for the recipient's messages, since for those recipients who have a suitable class of service provisioned in their HLR record, all MT messages will be delivered via the home network's SMS Router, even when the subscriber is roaming. The HLR's class of service feature allows this facility to be selectively offered to some or all customers. MO messages may also be handled according to the class of service by arranging for the SMS Router to query the HLR.

MT message delivery via the home network is seen as a vital component of future messaging services and is key to providing the recipient with control over his message management. The addition of selective HLR control of MT message delivery via the home network provides a class of service capability that allows an operator to offer advanced services to some or all customers. Such services include Divert, Copy, Log, Anti-Spam and location Privacy.

In so far as the embodiments of the invention described above may be implemented, at least in part, using software-controlled processing apparatus, it will be appreciated that a computer program providing such software control and a storage medium by which such a computer program is stored are envisaged as aspects of the invention.

1-8. (canceled)

9. A telecommunications services apparatus for use in a mobile telecommunications network, the apparatus comprising:
processing means for processing received text messages; and
call routing means operable:
to receive a routing information request signal indicative of a text message intended for a mobile terminal;
to return a routing information response signal indicative of the telecommunications services apparatus instead of being indicative of the intended mobile terminal; and
to control availability of processing of the text message based on subscriber specific information;
wherein the network includes a home location register storing said subscriber specific information so as to control the availability of text message processing.

10. Apparatus according to claim 9, wherein the home location register includes a settable flag for controlling the availability of the text message processing.

11. Apparatus according to claim 9, wherein the text message processing includes copying and/or diversion of the text message, interception of the text message, providing location privacy, anti-spam protection, access to diverted messages, and/or access to messages from other messaging systems.

12. Apparatus according to claim 10, wherein the text message processing includes copying and/or diversion of the text message, interception of the text message, providing location privacy, anti-spam protection, access to diverted messages, and/or access to messages from other messaging systems.

13. A telecommunications services method for a mobile telecommunications network, the method comprising:
receiving in a telecommunications services apparatus a routing information request signal indicative of a text message intended for a mobile terminal;
returning a routing information response signal indicative of the telecommunications services apparatus instead of being indicative of the intended mobile terminal; and
controlling availability of processing of the text message based on subscriber specific information;
wherein the network includes a home location register storing said subscriber specific information so as to control the availability of text message processing.

14. A method according to claim 13, wherein the home location register includes a settable flag for controlling the availability of the text message processing.

15. A method according to claim 12, wherein the text message processing includes copying and/or diversion of the text message, interception of the text message, providing location privacy, anti-spam protection, access to diverted messages, and/or access to messages from other messaging systems.

16. A method according to claim 14, wherein the text message processing includes copying and/or diversion of the text message, interception of the text message, providing location privacy, anti-spam protection, access to diverted messages, and/or access to messages from other messaging systems.

17. A computer program product having a computer readable medium having recorded thereon a computer program having computer executable instructions, which when loaded on to a computer is operable to cause the computer to perform a telecommunications services method for a mobile telecommunications network, the method comprising:
receiving in a telecommunications services apparatus a routing information request signal indicative of a text message intended for a mobile terminal;
returning a routing information response signal indicative of the telecommunications services apparatus instead of being indicative of the intended mobile terminal; and
controlling availability of processing of the text message based on subscriber specific information;
wherein the network includes a home location register storing said subscriber specific information so as to control the availability of text message processing.
